(19) United States
(12) Patent Application Publication
(10) Pub. No.: US 2021/0382729 A1
(43) Pub. Date: Dec. 9, 2021

(54) DYNAMIC MODIFICATION OF APPLICATION

(71) Applicant: Hewlett-Packard Development Company, L.P., Spring, TX (US)

(72) Inventors: Ajay SHARMA, Hungtington Beach, CA (US); Hyoeun KIM, Seongnam-si (KR); Wuseok JANG, Seongnam-si (KR); Semen ABYKOV, Seongnam-si (KR); Juho EUM, Seongnam-si (KR); Yunjong LEE, Seongnam-si (KR); Hye Heon JUNG, Seongnam-si (KR); Eun-Kyung YUN, Seongnam-si (KR)

(21) Appl. No.: 17/285,515

(22) PCT Filed: Nov. 6, 2018
(86) PCT No.: PCT/US2018/059379

§ 371 Date: Apr. 15, 2021

(51) Int. Cl. G06F 9/445; G06F 9/451

(52) U.S. Cl. CPC G06F 9/44505; G06F 9/451

(57) ABSTRACT

An electronic apparatus and a method of operating an electronic apparatus are provided. The method includes receiving an application including at least one of a user interface (UI) element, a data element, or a logical element, receiving a modifiability file indicating one or more of the at least one of the user interface (UI) element, the data element, or the logical element of the application that can be modified and an extent of the modifiability, installing the application including the modifiability file on the electronic apparatus, receiving a user selection to modify one or more of the UI element, the data element, or the logical element, creating a modification file based on the user modification, and storing the modification file for user selection and execution.

### BACKGROUND

An image forming apparatus (IFA) is typically supplied with applications for controlling the IFA, such as an application to control basic functions such as printing, copying, scanning, etc. To allow for tailored applications, for example an application that reflects a user's specific requirements or desired parameters, an IFA vendor may provide an open-platform that allows the vendor, a user, or a third-party developer to implement a desired application on the IFA's software platform. In that case, an application may be written based on a user's requirements. However, if the user wants to implement a change to the basic application or the tailored application, a new application is required.

### BRIEF DESCRIPTION OF DRAWINGS

The above and other aspects, features, and advantages of certain examples of the present disclosure will be more apparent from the following description taken in conjunction with the accompanying drawings, in which:

FIG. 1 is a diagram of a system for providing an application, providing a modifiability file, creating a modification file, and implementing the modification file according to an example.

FIG. 2 illustrates an electronic apparatus according to an example.

FIG. 3 illustrates a form that may be created by a user when modifying an application using a modifiability file according to an example.

FIG. 4 illustrates an application installation package including a modifiability file according to an example.

FIG. 5 illustrates a user interface with which a developer may associate a modifiability file, according to an example.

FIG. 6A illustrates a user interface that may be provided for in-app modding and FIG. 6B illustrates an activity window that may be provided to modify the user interface according to an example.

FIGS. 7A and 7B illustrate examples of a mod editor that may be provided for out-of-app modding.

FIG. 8 illustrates a user interface provided by a mod editor according to an example.

FIGS. 9A-9C illustrate top level buttons that may be displayed on an electronic apparatus before and after installation of a modification file according to various examples.

FIG. 10 illustrates a method of operating an electronic apparatus according to an example.

Throughout the drawings, it should be noted that like reference numbers are used to depict the same or similar elements, features, parts, components, and structures and thus, a repeated description thereof may be omitted.

### DETAILED DESCRIPTION OF EXAMPLES

Hereinafter, various examples will be described with reference to the accompanying drawings. In this regard, the examples may have different forms and should not be construed as being limited to the descriptions set forth herein. In order to further clearly describe features of the examples, descriptions of other features that are well known to one of ordinary skill in the art are omitted.

Expressions such as “at least one of,” when preceding a list of elements, modify the entire list of elements and do not modify the individual elements of the list.

In the specification, when an element is “connected” to another element, the elements may not only be “directly connected,” but may also be “connected” via another element therebetween, unless otherwise described. Also, when a region “includes” an element, the region may further include another element instead of excluding the other element, unless otherwise differently stated.

In the following description, an electronic apparatus may refer to, but is not limited to, an image forming apparatus (IFA) such as a printer, a copier, a scanner, a facsimile machine, or a multi-functional printer (MFP) which may include two or more of such functions. Further, an electronic apparatus may refer to, but is not limited to, a smartphone, a tablet personal computer (PC), a mobile phone, a video telephone, an electronic book reader, a laptop PC, a netbook computer, a workstation, a server, a personal digital assistant (PDA), a portable multimedia player (PMP), a Motion Picture Experts Group (MPEG-1 or MPEG-2) Audio Layer 3 (MP3) player, a mobile medical device, a camera, or a wearable device (for example, smart glasses, head-mounted-devices (HMDs), or smart watches). In addition, an electronic apparatus may refer to, but is not limited to, a smart home appliance such as a television (TV), a digital versatile disc (DVD) player, a refrigerator, an air conditioner, a washing machine, a set-top box, a home automation control panels, an electronic picture frame, or the like.

In the following description, an operating system (OS) may refer to, but is not limited to, an OS that is provided with an electronic apparatus by a manufacturer, an OS that is provided by an external supplier, or the like. Examples of OSs may include Microsoft Windows™, Apple macOS™, Google Android™, Apple iOS™, Linux OS™, Chrome OS™, BlackBerry Tablet OS™, and the like.

It is to be understood that blocks in the accompanying diagrams and compositions of operations in flowcharts can be performed by computer program instructions. These computer program instructions can be provided to processors of, for example, general-purpose computers, special-purpose computers, and programmable data processing apparatuses. Therefore, the instructions performed by the computer or the processors of the programmable data processing apparatus generate means for executing functions described in the blocks in the block diagrams or the operations in the flowcharts. The computer program instructions can be stored in a computer available memory or a computer readable memory of the computer or the programmable data processing apparatus in order to realize the functions in a specific manner. Therefore, the instructions stored in the computer available memory or the computer readable memory can manufacture products including the instruction means for performing the functions described in the blocks in the block diagrams or the operations in the flowcharts. Also, the computer program instructions can be loaded onto the computer or the computer programmable data processing apparatus. Therefore, a series of operations is performed in the computer or the programmable data processing apparatus to generate a process executed by the computer, which makes it possible for the instructions driving the computer or the programmable data processing apparatus to provide operations of executing the functions described in the blocks of the block diagrams or the operations of the flowcharts.

Each block or operation may indicate a portion of a module, a segment or a code including one or more executable instructions to perform a specific logical function (or functions). It should be noted that, in some examples, the functions described in the blocks or the operations may be generated out of order. For example, two blocks or operations that are continuously shown can be actually performed at the same time, or they can sometimes be performed in reverse order according to the corresponding functions.

Each of the respective components in the following examples refers to, but is not limited to, a software or hardware component, such as a Field Programmable Gate Array (FPGA), an Application Specific Integrated Circuit (ASIC), or the like. A module may be advantageously configured to reside on an addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

As technology has progressed, an electronic apparatus may be provided with various applications for controlling its use. For example, in the case of an IFA, various applications may be installed on the IFA for controlling its basic operations such as printing, copying, scanning, and the like. In that case, a vendor of the IFA may not provide more advanced applications because it is unknown which applications would be of use to the client. However, the vendor of the IFA may provide access to the vendor's software platform in order for the client or a third-party to create an application that is tailored to the client's needs. As such, a tailored application may be written by the vendor, the client, or the third-party and installed on the IFA. However, as with the provided applications, if the client desires to modify the tailored application, a new application must be written and installed. This requires additional costs for items such as development, testing, marketing, and the like in order to provide the modified application.

As will be described in more below, a modifiability file, which may be referred to herein as a .mof file for convenience, may be created by a developer and associated with an application. The modifiability file allows the developer of the application to describe and designate which aspects of an application may be modified and to what extent the modifications may be made. When a user, such as an administrator, of the electronic apparatus desires to make a change to an application using the modifiability file, the user may modify the application using a modification editor at either the electronic apparatus itself, or at a remote terminal. Based on the desired changes, a modification file is created for installation on the electronic apparatus. The modification file may be referred to herein as a .mod file for convenience. Upon installation, the modification file may be used in addition to or in place of the original application that has been modified. Additionally, a plurality of modifiability files may be associated with the application, and a plurality of modification files may be applied to the application.

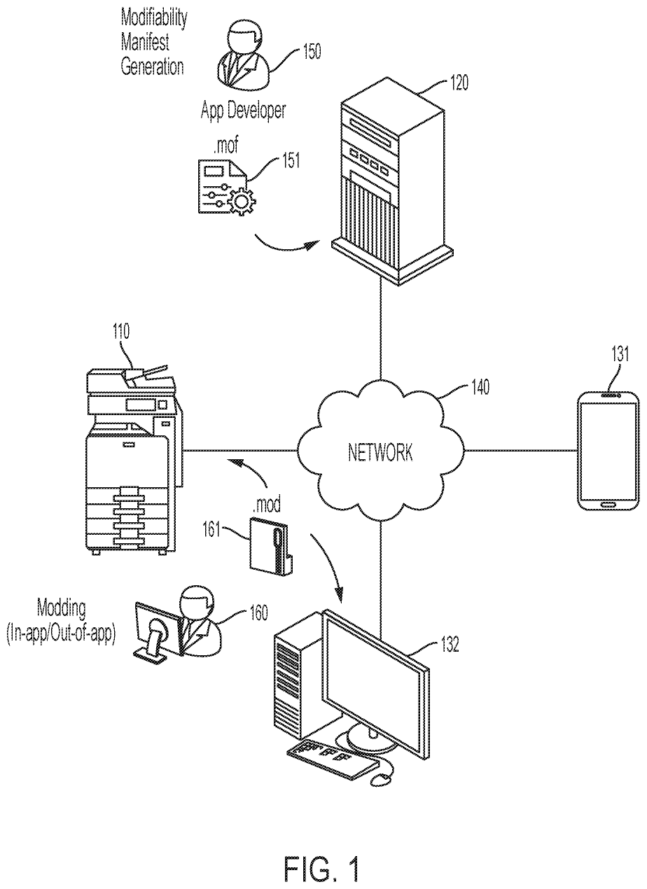

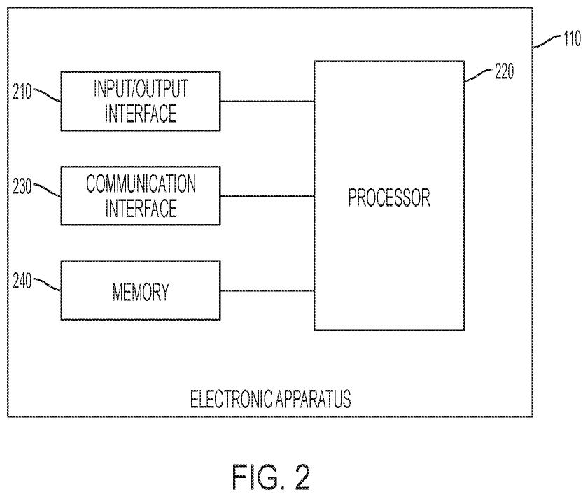

FIG. 1 is a diagram of a system for providing an application, providing a modifiability file, creating a modification file, and implementing the modification file according to an example. FIG. 2 illustrates an electronic apparatus according to an example.

Referring to FIGS. 1 and 2, a system may include an electronic apparatus 110, a server 120, and user terminals 131 and 132. The electronic apparatus 110, the server 120, and the user terminals 131 and 132 may be connected to a network 140. In the example of FIG. 1, the electronic apparatus 110 is implemented as an image forming apparatus. However, it is to be understood that this is merely an example and that the electronic apparatus 110 is not so limited.

In the example of FIG. 1, the image forming apparatus refers to any apparatus, such as a printer, a copier, a scanner, a fax machine, a multi-function printer (MFP), or a display, that is capable of performing an image forming job. The image forming job may refer to image formation or various jobs (e.g., printing, copying, scanning, or faxing) related to an image, for example, creation, storage, transmission, etc. of an image file, and the job may refer to not only the image forming job but also a series of processes required to perform the image forming job.

Referring to FIG. 2, the electronic apparatus 110 may include an input/output interface 210, a processor 220, a communication interface 230, and a memory 240. Although not illustrated, the electronic apparatus 110 may further include a power supply for supplying power to each component, as well as additional components as may be desired by a user.

The input/output interface 210 may include an input interface for receiving an input for performing an application or executing a function from a user, and an output interface for displaying information, such as a result of performing the application, executing a function, or a state of the electronic apparatus 100. For example, the input/output interface 210 may include an operation panel for receiving a user input and a display panel for displaying a screen.

In more detail, the input interface 210 may include a device for receiving various types of user inputs, such as a keyboard, a physical button, a touch screen, a camera, a microphone, or the like. Also, the output interface may include, for example, a display panel, a speaker, or the like. However, the input/output interface 210 is not limited thereto and may include any device supporting various inputs and outputs.

The processor 220 may control operations of the electronic apparatus 110, and may include at least one processor, such as a central processing unit (CPU). The processor 220 may control other components included in the electronic apparatus 110 to perform an operation corresponding to a user input received through the input/output interface 210. In that regard, the processor 220 may include two or more OSs for controlling operations of the electronic apparatus 110 and for controlling applications installed on the electronic apparatus and stored in the memory 240. Furthermore, the OSs may be heterogeneous OSs.

The processor 220 may include at least one specialized processor for each function or may be an integrated processor. For example, the processor 220 may execute a program stored in the memory 240, read data or a file stored in the memory 240, or store a new file in the memory 140. The processor 220 may also include an application specific integrated circuit (ASIC) that may be partitioned for use with the plurality of OSs.

The communication interface 230 may communicate with another device such as user terminals 131 and 132, or with the server 120 using the network 140 in a wired or wireless manner. To this end, the communication interface 230 may include a communication module, such as a transceiver, supporting at least one of various wired/wireless communication methods. For example, the communication module may be in a form of a chipset, may be a sticker/barcode (for example, a sticker including a near-field communication (NFC) tag) containing information required for communication, or the like.

The wireless communication may include at least one of, for example, Wi-Fi, Wi-Fi direct, Bluetooth, ultra-wideband (UWB), NFC, or the like. The wired communication may include at least one of, for example, a universal serial bus (USB), a high definition multimedia interface (HDMI), or the like.

Names of the above components of the electronic apparatus 110 may be changed. Also, the electronic apparatus 110 may include at least one of the above components, and may not include some of the above components or may further include an additional component.

Referring again to FIG. 1, the server 120 may be a local server, a remote server, a cloud server, etc. In implementation, the server 120 may be a server that is local to the electronic apparatus 110 and owned or otherwise controlled by the same entity as the electronic apparatus 110, or may be a server 120 that is remote from the electronic apparatus 110 and owned or otherwise controlled by a vendor of the electronic apparatus 110. Still further, the server 120 may be either local or remote to the electronic apparatus 110 and owned or otherwise operated by a third party.

The user terminals 131 and 132 allow a user to access the electronic apparatus 110 and the server 120 using the network 140. The user terminals 131 and 132 may include, for example, a smartphone, a tablet, a PC, a camera, a wearable device, etc. Further, the user terminals 131 and 132 may have a basic configuration similar to that shown for the electronic apparatus 110 in FIG. 2. For example, each of the user terminals 131 and 132 may include a processor, an input/output interface, a communication interface, and a memory.

The network 140 connects the electronic apparatus 110, the server 120, and the user terminals 131 and 132 to one another. The server 120 may be connected to the user terminals 131 and 132 via the network 140 and provide a service to a user. The network 140 may be implemented as either a wired or wireless network.

A developer or other user 150 may create an application for use on the electronic apparatus 110. In that case, a user 160 of the electronic apparatus 110 may download or otherwise receive the application and install it for us on the electronic apparatus 110. The developer 150 may also create a modifiability file 151 for the application. In that case, user 160 of the electronic apparatus 110 may similarly download or otherwise receive the modifiability file 151 for the application and install it on the electronic apparatus 110. In an example, the modifiability file 151 may be provided with an installation package for the application itself. In another example, the modifiability file 151 may be provided separately. In the example of FIG. 1, the developer 150 may store the application and the modifiability file 151 on the server 120 for purchase or other access by a user, administrator, owner, etc. of the electronic apparatus 110.

With the application installed on the electronic apparatus 110, the user 160 of the electronic apparatus 110 may desire to change one or more aspects of the application to address a requirement of the user 160. For example, the user 160 may wish to change a characteristic of a user interface of the application that the developer 150 of the application has established as being modifiable through the modifiability file 151. In that case, the user 160 of the electronic apparatus 110 may create a modification file 161 that reflects the desired changes of the user 160. The modification file 161 may be stored by the user at any of the electronic apparatus 110, the server 120, the user device 131, 132, or may be stored on a portable memory device such as a USB memory, thumb drive, or the like.

The user 160 of the electronic apparatus 110 may use a mod editor to make the desired changes to create the modification file 161. The mod editor may be installed at either the electronic apparatus 110 or may be available as a web-based or desktop-based application. If available as a web-based or desktop-based application, the mod editor may be installed on the server 120 and available for use at either the user device 131 or 132, of may be installed directly on either the user device 131 or 132.

A more detailed explanation of a modifiability file and a modification file, as well as their creation and implementation, will be provided below.

A modifiability file is developed as a package that contains a modifiability manifest to describe an application's modifiability and defines the modifiability in terms of frames and fidgets. In general terms, a fidget is a logical unit of modifiability that is defined by the application developer for a desired modification of the application. A frame denotes a collection of fidgets, which allows for fidget interaction and management. The modifiability file also includes all assets in their default form.

A modification to an application is an alteration that changes some aspect of the application, such as how it looks or behaves. In implementation, the modification is reflected in a modification file that is a package containing the modification and all the developer supplied assets. It is considered a global resource, and is not specific to only one application. That is, applications adhering to a common modifiability file can easily work off the same modification file. As will be described below, by using the described modification framework including the modifiability and modification files, a user of the application will be able to customize applications with little or no software development.

A framework for creating a modifiability file and a modification file takes into account various aspects or requirements for their successful implementation. For example, a modification file should be able to alter a user interface (UI) element, a data element, a logical element, or a combination of the any of the above for a given application. The extent of modifiability, that is, what is modifiable within an application, is preferably managed by a single entity, such as the application developer. A modification file should be device neutral and should be user and technology agnostic. As an example, the same modification file for the same application may be applied to an electronic apparatus using an Android OS or an MS Windows OS. A modification file should be self-contained such that all assets (e.g., graphic resources, etc.) used by the modification file should be part of the modification file itself. A modification file should be portable (e.g., easily exported, archived, imported, etc.). A user should be able to modify an application in an in-app manner using an application providing a special mode for in-app modding and should be able to modify an application in an out-of-app manner using, for example, a web-based editing application or desktop-based editing application. Multiple modification files may be created for the same application and multiple modification files may be applied to the same application on the same device. Except for the mobile application cases, installation of a modification file on an electronic apparatus may create an additional top-level button, may modify the existing application's top-level button, or may simply install the mod without changing any launch behavior. A modification file is identified globally by its GUID or its UUID.

According to an example, a root element (e.g., <mof>) of a modifiability file provides a declaration for an extensible markup language (XML) schema instance (xsi) namespace and a hint to retrieve a corresponding schema. The attributes of a modifiability file are defined in Table 1.

TABLE 1

| Name | Type | Definition | Presence | Default |
|---|---|---|---|---|
| xmlns:xsi | String | Standard XML schema | Mandatory | n/a |
| | | instance namespace | | |
| xsi:noNamespace | String | URL to retrieve the | Mandatory | n/a |
| SchemaLocation | | schema definition | | |
| schemaVersion | Semver | Manifest Version | Mandatory | n/a |
| | String | used to create | | |
| | | this instance. | | |
| | | The patch portion | | |
| | | of semver is | | |
| | | not used. | | |

The children of the modifiability root element include a frame element which occurs one or more times. In implementation, a frame element provides a logical grouping of fidgets. Also, a frame element may provide a physical correlation with a UI screen but this is purely at the developer's discretion. The attributes of a frame element are defined in Table 2.

TABLE 2

| Name | Type | Definition | Presence | Default |
|---|---|---|---|---|
| ID | String | Unique frame id to | Mandatory | n/a |
| | | identify the frame | | |
| TYPE | String | Type of frame | Optional | |

The TYPE attribute assists in grouping fidgets, which assists an external tool in treating them differently, as needed. Different TYPES of frame elements are defined in Table 3.

TABLE 3

| Type | Description |
|---|---|
| MACROS | A frame containing fidgets, which act as MACROS. The |
| | value of such fidgets is computed during the run time. |
| WIDGETS | A frame containing fidgets to be used as widgets for |
| | dynamic .mof generation. |
| IN.LINKSPEC | A frame carrying fidgets, which define the inbound |
| | interface (e.g., link spec for a linkable) of an app |
| | (i.e., linkable). This is not a mod related feature. |

The children of a frame element include a fidget, which occurs one or more times and provides a basic unit of modification. The attributes of a fidget are defined in Table 4.

TABLE 4

| Name | Type | Definition | Presence | Default |
|---|---|---|---|---|
| Id | String | Unique fidget id to | Mandatory | n/a |
| | | identify the fidget | | |
| Type | Enum | Type of fidget | Optional | “custom” |
| Include | Path String | Path of the parent | Optional | n/a |
| | | fidget | | |

The Type attribute helps group fidgets when retrieving them at the time of application. That is, data elements can be applied ahead of time before a UI layer is rendered. It also helps perform some constraint checks if an external tool is being used to create a modification file. The different Types of fidgets are defined in Table 5.

TABLE 5

| Type | Description |
|---|---|
| VIEW | A fidget impacting the cosmetics of an |
| | element(s) (e.g., visibility, accessibility, |
| | color, shape, icon, etc.). |
| MODEL | A fidget impacting the model values of an |
| | element(s). e.g. selection criteria, auto- |
| | selected, default etc. |
| MODEL_VIEW | A combination of the MODEL and VIEW |
| CUSTOM | Any Custom behavior |

Frame type = IN.LINKSPEC or OUT.LINKSPEC

| | |
|---|---|
| ACTIVITY | A fidget representing an Android |
| | Activity |
| SERVICE | A fidget representing an Android |
| | Service |
| BROADCAST | A fidget representing an Android |
| | Broadcast |

Frame type = WIDGETS

| | |
|---|---|
| WIDGET_EDIT_TEXT | A fidget representing a EditText widget |
| WIDGET_SWITCH | A fidget representing a switch widget |
| WIDGET_RADIO | A fidget representing a Radio widget |
| WIDGET_CHECKBOX | A fidget representing a Check box widget |
| WIDGET_LABEL | A fidget representing a Label widget |
| WIDGET_DATE_PICKER | A fidget representing a Date Selector |
| | widget |
| WIDGET_TIME_PICKER | A fidget representing a Time Selector |
| | box widget |
| WIDGET_LIST | A fidget representing a List |
| | (single column) widget |
| WIDGET_BUTTON | A fidget representing a Button widget |
| WIDGET_SLIDER | A fidget representing a Slider widget |
| WIDGET_SEPERATOR | A fidget representing a separator or gap |

The children of a fidget include a description (<descr>) element which may not occur or may occur one time, a property (<prop>) element, which occurs one or more times, and a set (<set>) element, which may not occur or may occur one or more times.

The description element provides a localized description of its parent. The description element has one child element of a locale string (<locale string>), which occurs one or more time.

A fidget may have one or more property elements, a description of which is provided in its description element. Notably, the number of properties are only limited by the extent of modifiability that a developer wishes to expose for a fidget. The attributes of the property element are defined in Table 6 and the types of the property element are defined in Table 7.

TABLE 6

| Name | Type | Definition | Presence | Default |
|---|---|---|---|---|
| Id | String | Unique fidget id to identify the | Mandatory | n/a |
| | | fidget. | | |
| Type | Enum | Type of property. | Optional | “STR” |
| Value | String | Value assigned to the property. | Mandatory | n/a |
| | | A value starting with a #, | | |
| | | indicates a hexadecimal value | | |
| Editable | Boolean | Indicates if this property can be | Optional | “false” |
| | | edited. | | |

TABLE 7

| Type | Value |
|---|---|
| STR | String |
| LSTR | Localized string for English. The rest of the locales are |
| | provided under <\|10n_value>. |
| MSTR | A macro enabled string. Any literal contained within |
| | { } is replaced by the value of a fidget, |
| | matching the literal. Such fidgets must be part of |
| | a frame of type “MACROS.” |
| MLSTR | A macro enabled localized string. Similar to MSTR. |
| | However, it requires a locale (typically the current locale |
| | of the device) to be selected prior to macro expansion. |
| INT | Number |
| BOOL | “true” or “false” |
| URL | URL or URI |
| ASSET | A file based asset. Assets can be scalable or fixed. |
| COLOR | Color in hexadecimal (AARRGGBB) |
| CALENDAR | Date (UTC) |
| TIME | Time (UTC) |
| TIMESTAMP | Date/Time stamp (UTC) |
| MOD_ID | GUID of a Mod; this is required by the ALF to identify a |
| | MOD |
| MD_FORM | A .mof file containing an end user created form using the |
| | widgets offered by the developers to collect metadata. |
| | This .mof file has only 1 frame of the type MACROS. |
| MD_SPEC | A comma separated list of macros to be added to the |
| | metadata. The macros are expanded and written to a file, |
| | which is then used for metadata submission. |
| XBOOL | True, false or a predicate in an XPath notation. |
| | The XPath predicate is used to create runtime |
| | dependencies among fidgets based on one or |
| | more properties of one (e.g., determine if |
| | a fidget should be enabled or hidden or |
| | something else based on the value of the |
| | property of another fidget). Macros are |
| | not allowed in an XPath predicate. |

The children of the property element include a localization value (<110n_value>), which, for the LSTR type, must occur one or more times. The localization value element provides a localized value of its parent and has as its children element a locale string (<locale string>), which occurs one or more time.

A fidget may have one or more set (<set>) element and the set element may have one or more item (<item>) element, where each item can have multiple property elements. The attributes of a set element are defined in Table 8.

TABLE 8

| Name | Type | Definition | Presence | Default |
|---|---|---|---|---|
| key | String | Key connecting | Mandatory | n/a |
| | | the data set to a | | |
| | | collection in the | | |
| | | application model. | | |
| multiValued | Boolean | Indicates, if | Optional | “false” |
| | | multiple values | | |
| | | can be selected. | | |
| type | Enum | Type of property. | Optional | “STR” |

The children elements of the set element include an item (<item>) element, which occurs one or more times. The attributes of the item element are defined in Table 9.

TABLE 9

| Name | Type | Definition | Presence | Default |
|---|---|---|---|---|
| Key | String | Key connecting the | Mandatory | n/a |
| | | data item to an entry | | |
| | | (row) in a collection | | |

The children elements of the item element include a property (<prop>) element that occurs one or more times.

Regarding localization, a LSTR type property element indicates a localized string. The localized values may be provided by the localization element. An example implementation of the localization element may be:

<prop key=″title″ type=″LSTR″ value=″Windows Title″ editable=″true″ >

<descr>

<locale key=”en”> Locale specific text for Window's title </en>
< locale key=”fr”> Texte spécifique aux paramètres régionaux

pour le titre de Windows </locale>

< locale key=”es”> Texto específico de la configuración

regional para el título de la ventana </locale>

</descr>
<|10n_value>

<locale key=”fr”> Titre </locale>
<locale key=”es”> Título </locale>

</10n_value>

</prop>

Regarding assets handling, the framework supports user supplied assets. These assets may relate to a display density and be a scalable kind or a fixed kind. A scalable asset may be specified in a relative form. An example of a scalable asset may be:

<prop name=“backgroundImage” type=“ASSET” value=“bg.png”
editable=“true”/>

On the other hand, a fixed asset may be provided in an absolute form. An example of a fixed asset may be:

<prop name=“sound” type=“ASSET” value=“/bang.mp3”
editable=“true”/>

A generic nomenclature of a scaling multiplier may be used to provide different density assets. Using the example above, the developer has to provide the assets defined in Table 10 in a final modification file.

TABLE 10

| | | |
|---|---|---|
| /res | | |
| | bang.mp3 | |
| | /x0.75 | |
| | | bg.png |
| | /x1 | |
| | | bg.png |
| | /x2 | |
| | | bg.png |
| | /x3 | |
| | | bg.png |

However, if the developer had defined the ‘backgroundImage’ as:

<prop name=“backgroundImage” type=“ASSET” value=“/bg.png”
editable=“true”/>

then only the assets that would be required are defined in Table 11.

TABLE 11

| | |
|---|---|
| /res/ | |
| | bg.png |
| | bang.mp3 |
| | /x0.75 |
| | /x1 |
| | /x2 |
| | /x3 |

The scale factor can be easily mapped to different UI platforms. For example, for an Android based application, ‘x1’ maps to ‘mdpi’ and x2 maps to ‘xhdpi’.

The modifiability file 151, can also be used to capture dynamic/interactive information from the end user, such as the user's department, the user's billing code, and the like. This is typically referred as ‘metadata’. Regarding handling of metadata, metadata support is concerned with two aspects. The first one addresses the concern of how and what data should be collected from the user. The second one addresses how this collected data should be presented to the service.

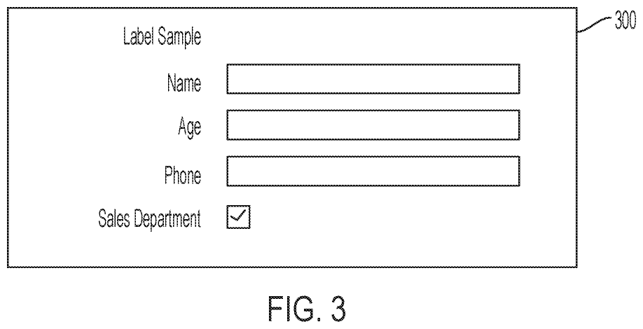

As an example of handling of metadata, a modifiability file supports form creation via a dedicated frame element of the type WIDGET. An example of a form creation is provided with reference to FIG. 3

FIG. 3 illustrates a form that may be created by a user when modifying an application using a modifiability file according to an example.

Referring to FIG. 3, a form 300 may be created using a frame type designated as a WIDGET. As described above, a WIDGET type frame contains widgets (defined in terms of fidgets) that can be used to populate a form by the user. The composed form is represented by the MD_FORM type property. An example of an ‘editText’ widget, with its supported properties, is provided as follows:

frame id=″widgets″ type=″WIDGETS″>

<fidgets>

<fidget id=″editText″ type=″WIDGET_EDIT_TEXT″ >

<descr>

<locale key= ”en”> Text Field </locale>

</descr>
<props>

<prop key=″text″ type=″STR″ value=″″ />
<prop key=″isPassword″ type=″BOOL″ value=″false″ />
<prop key=″hint″ type=″LSTR″ value=″false″ />
<prop key=″tabOrder″ type=″INT″ />
<prop key=″enable″ type=″BOOL″ value=″true″ />
<set key=″inputType″ multiValued=″false″ type=″STR″ >

<items>

<item key=″email″/>
<item key=″phone″/>

</items>

</set>

</props>

</fidget >
<fidget id=″cb″ type=″WIDGET_CHECKBOX″ >

<descr>

<locale key= ”en”> Checkbox </locale>

</descr>
<props>

<prop key=″text″ type=″STR″ value=″″ />
<prop key=″tabOrder″ type=″INT″ />
<prop key=″enable″ type=″BOOL″ value=″true″ />
<set key=″dept″ multiValued=″false″ type=″STR″ >

<items>

<item key=″sales″>

<props>

<prop key=″title″ type=″STR″ value=″Sales Dept.″

/>

<prop key=″selected″ type=″BOOL″ value=″true″

/>

</props>

</item>

</items>

</set>

</props>

</fidget >

</fidgets>

</frame>

The widgets become available when the user creates a form, by editing the following property:

<prop key=“form” type=“MD_FORM” value=“myForm.xml”

editable=“true” />

In FIG. 3, the form 300 can be represented by a modifiability file as follows:

<?xml version=″1.0″ encoding=″UTF-8”?>
<mof xmlns:xsi=″http://www.w3.org/2001/XMLSchema-instance″
xsi:noNamespaceSchemaLocation=″http://some.host.hp.com/JetAdvantageL
ink/App/ModifiabilityManifestSchema.xsd″ schemaVersion=″1.1″ >

<frames>

<frame id=″myForm″ type=”MACROS”>

<fidgets>

<fidget id=″label″ type=″WIDGET_LABEL″ >

<props>

<prop key=″text″ type=″LSTR″ value=″Label Sample″ />

</props>

</fidget>
<fidget id=″name″ type=″WIDGET_EDIT_TEXT″ >

<props>

<prop key=″text″ type=″STR″ value=″″ />
<prop key=″isPassword″ type=″BOOL″ value=″false″ />
<prop key=″hint″ type=″LSTR″ value=″Enter your name″ />
<prop key=″tabOrder″ type=″INT″ value=″2″/>
<prop key=″enable″ type=″BOOL″ value=″true″ />
<set key=″inputType″ multiValued=″false″ type=″STR″ >

<items>

<item key=″email″>

<props>

<prop key=″title″ type=″STR″ value=″Email″ />
<prop key=″selected″ type=″BOOL″ value=″false″ />

</props>

</item>
<item key=″phone″>

<props>

<prop key=″title″ type=″STR″ value=″Phone″ />
<prop key=″selected″ type=″BOOL″ value=″false″ />

</props>

</item>
<item key=″name″>

<props>

<prop key=″title″ type=″STR″ value=″Name″ />
<prop key=″selected″ type=″BOOL″ value=″true″ />

</props>

</item>

</items>

</set>

</props>

</fidget>
<fidget id=″phone″ type=″WIDGET_EDIT_TEXT″ >

<props>

<prop key=″text″ type=″STR″ value=″″ />
<prop key=″isPassword″ type=″BOOL″ value=″false″ />
<prop key=″hint″ type=″LSTR″ value=″Enter your phone″ />
<prop key=″tabOrder″ type=″INT″ value=″2″/>
<prop key=″enable″ type=″BOOL″ value=″true″ />
<set key=″inputType″ multiValued=″false″ type=″STR″ >

<items>

<item key=″email″>

<props>

<prop key=″title″ type=″STR″ value=″Email″ />
<prop key=″selected″ type=″BOOL″ value=″false″ />

</props>

</item>
<item key=″phone″>

<props>

<prop key=″title″ type=″STR″ value=″Phone″ />
<prop key=″selected″ type=″BOOL″ value=″true″ />

</props>

</item>
<item key=″name″>

<props>

<prop key=″title″ type=″STR″ value=″Name″ />
<prop key=″selected″ type=″BOOL″ value=″false″ />

</props>

</item>

</items>

</set>

</props>

</fidget>

<fidget id=″dept″ type=″WIDGET_CHECKBOX″ >

<props>

<prop key=″enable″ type=″BOOL″ value=″true″ />
<set key=″dept″ multiValued=″false″ type=″STR″ >

<items>

<item key=″sales″>

<props>

<prop key=″title″ type=″STR″ value=″Sales Dept.″ />
<prop key=″selected″ type=″BOOL″ value=″true″ />

</props>

</item>

</items>

</set>

</props>

</fidget>

</fidgets>

</frame>

</mof>

The metadata content definition involves specifying what metadata elements are to be included in a metadata file. This content definition is represented by a dedicated property type MD_SPEC, such as:

<prop key=“file-format” type=“MD_SPEC” value=“TIMESTAMP,
JOB_FILE_NAMES, dept” editable=“true” />

Editing this property allows an end user to select macros from a collection created by combining a MACRO frame created by the developer as well as a frame created by the end user (via the form 300).

The macros selected in the property are expanded during the metadata file creation time. Using the above property as an example, and considering xml as a chosen mime, an example metadata file content may include:

<?xml version=″1.0”?>
<metadata xmlns:xsi=″http://www.w3.org/2001/XMLSchema-instance″
xmlns:xsd=″http://www.w3.org/2001/XMLSchema″ version=″1.0″>

<jobInfo>

<prop key=″TIMESTAMP″ type=″TIMESTAMP″

value=″03/01/2018T14:00:00″/>

<!-- JOB_FILE_NAMES expansion: does not have to be in a property

format. The developer can pick any appropriate format -->

<files>

<file> foo1.pdf </file>
<file> foo2.pdf </file>
<file> foo3.pdf </file>

</files>
<prop key=″dept″ type=″STR″ value=″sales″/>

</jobInfo>

</metadata>

Thus, the metadata concerns may be addressed using the MD_FORM and MD_SPEC property types.

The above description has provided examples of various elements to be considered by a developer when creating a modifiability file. Once the modifiability file is completed, it may be provided to an electronic apparatus. An example of providing a modifiability file to an electronic apparatus is by including the modifiability file in an application installation package, which is described below.

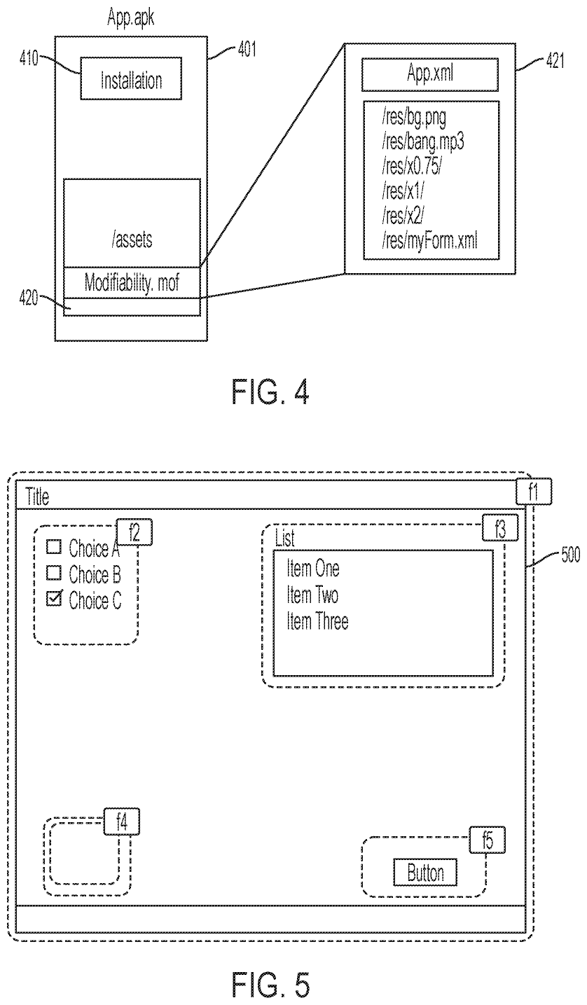

FIG. 4 illustrates an Android application installation package including a modifiability file according to an example.

Referring to FIG. 4, an application installation package 401 may include several containers such as a first container including an installation file and a second container 420 including asset information for the application installation file. The application installation package 401 may include additional containers, as well as additional information, data, and other files as may be necessary.

The first container 410 may include an application installation file corresponding to the OS of the electronic apparatus. For example, if the application installation package 401 was for an Android OS based application, the first container 410 may include an installation file (i.e., an .apk extension file) for installation on the Android OS.

The second container 420 may include information or files related to resources needed for execution of the application. The second container 420 may also include modifiability information 421 and all files and assets in their default form. In implementation, the modifiability information, comprising all the files and assets in their default form, may be named as “Modifiability.mor” so as to maintain a consistent naming format for user convenience. In an example, the modifiability file is placed in an assets folder of the second container 420. The application installation package 401 may be provided to a user, may be stored for future retrieval, may be transmitted or otherwise supplied to an electronic apparatus, and the like.

As an example of creating a modifiability file for use on an electronic apparatus using the Android OS, a supplied Android Studio (IntelliJ) plugin may be used to assist with the creation of the App.xml and for importing of assets and final packaging. This plugin may be used during the development time to create the modifiability file in a similar manner as the way a UI layout is created. Furthermore, both “design” and “text” modes are supported.

While the various characteristics and definitions of a modifiability file have been described above, an example application of creating a modifiability file will be provided hereinafter.

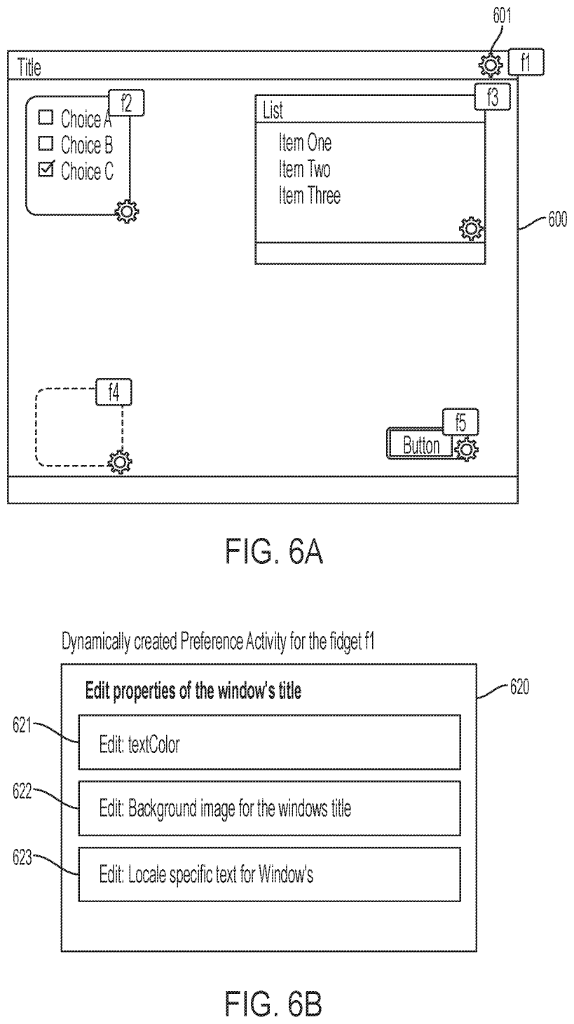

FIG. 5 illustrates a user interface with which a developer may associate a modifiability file, according to an example.

Referring to FIG. 5, a developer may associate a user interface 500 with various fidgets that the developer has exposed for modification. In the example of FIG. 5, the developer has exposed or defined a first fidget f1 of a VIEW type, a second fidget f2 of a MODEL type, a third fidget f3 of a MODEL-VIEW type, a fourth fidget f4 of a CUSTOM type, and a fifth fidget f5 also of a CUSTOM type. Although not illustrated in FIG. 4, the developer has also defined a fidget f0 that may be considered a logical or common fidget that may be used for programming convenience.

In the example of FIG. 5, the f0 fidget may be a VIEW type fidget. Thus, when introduced with the modifiability file, the f0 fidget may be represented with the following code:

<?xml version=″1.0″ encoding=″UTF-8”?>
<mof xmlns:xsi=″http://www.w3.org/2001/XMLSchema-instance″
xsi:noNamespaceSchemaLocation=″http://www.hp.com/schemas/jeta
dvantage/link/ModifiabilityManifestSchema.xsd″
schemaVersion=″1.1″ >

<frames>

<frame id=″com.acme.theme″>

<fidgets>

<fidget id=″f0″ type=″VIEW″ >

<props>

<!-- Example of a hexadecimal value -->
<prop key=″textColor″ type=″COLOR″

value=″#00ff0000″ editable=″true″ />

<!-- Example of a scalable asset -->
<prop key=″backgroundImage″ type=″ASSET″

value=″bg.png″ editable=″true″>

<descr>

<locale key=″en″> Edit properties of the

window's title </locale>

</descr>

</prop>

</props>

</fidget>

</fidgets>

</frame>
<frame id=″com.acme.widgets″ type=”WIDGETS”>
</frame>
<frame id=″com.acme.macros″ type=”MACROS”>

<fidgets>

<fidget id=″HOST_IP″ type=″CUSTOM″ >

<props>

<!-- Macros -->
<!-- These are resolved at run time by the app -->
<prop key=″HOST_IP″ type=″STR″ value=″″ >

<descr>

<locale key=″en″> Device IP </locale>

</descr>

</prop>

</props>

</fidget>
<fidget id=″JOB_ID″ type=″CUSTOM″ >

<props>

<prop key=″JOB_ID″ type=″STR″ value=″″ >

<descr>

<locale key=″en″> Job Id </locale>

</descr>

</prop>

</props>

</fidget>
<fidget id=″TIMESTAMP″ type=″CUSTOM″ >

<props>

<prop key=″TIMESTAMP″ type=″TIMESTAMP″ value=″″

>

<descr>

<locale key=″en″> Timestamp </locale>

</descr>

</prop>

</props>

</fidget>
<fidget id=″JOB_FILE_NAMES″ type=″CUSTOM″ >

<props>

<prop key=″JOB_FILE_NAMES″ type=″STR″ value=″″ >

<descr>

<locale key=″en″> List of Impression file

names</locale>

</descr>

</prop>

</props>

</fidget>

</fidgets>

</frame>

The f1 fidget is defined as a VIEW type of fidget and may be used to adjust or alter the look of an element, such as the color, shape, or other properties of a background window of the user interface 500. In that regard, the f1 fidget may be represented with the following code:

<frame id=″com.acme.app.main″ >

<fidgets>

<fidget id=″f1″ type=″VIEW″ include=″com.acme.theme/f0″ >

<descr>

<locale key= ”en”> Edit properties of the window's title

</locale>

<locale key=”fr”> Modifier les propriétés pour le titre de

la fenêtre </locale>

<locale key=”es”> Editar propiedades para el título de

la ventana </locale>

</descr>
<props>

<!-- Example of a Locale sensitive string -->
<prop key=″title″ type=″LSTR″ value=″Title″

editable=″true″ >

<descr>

<locale key=”en> Locale specific text for

Window's title </ locale>

<locale key=”fr> Texte spécifique aux paramètres

régionaux pour le titre de Windows </locale>

clocale key= ”es> Texto específico de la

configuración regional para el titulo de la ventana </locale>

</descr>
<|10n_value>

<locale key=”fr”> Titre </locale>
<locale key=”es”> Titulo </locale>

</|10n_value>

</prop>

</props>

</fidget >

The f2 fidget is defined as a MODEL type of fidget and may be used to define model values such as a selection criteria, a default value, etc. In that regard, the f2 fidget may be represented with the following code:

<fidget id=″f2″ type=″MODEL″ >

<descr>

< locale key=”en”> Select choices from the below list</locale>

</descr>
<set key=″choices″ _multiValued=″true″ type=″STR″ >

<items>

<item key=″choice_a″>

<props>

<prop key=″title″ type=″STR″ value=″Choice A″ />
<prop key=″selected″ type=″BOOL″ value=″false″

editable=″true″/>

</props>

</item>
<item key=″choice_b″>

<props>

<prop key=″title″ type=″STR″ value=″Choice B″ />
<prop key=″selected″ type=″BOOL″ value=″true″

editable=″true″/>

</props>

</item>
<item key=″choice_c″>

<props>

<prop key=″title″ type=″STR″ value=″Choice C″ />
<prop key=″selected″ type=″BOOL″ value=″true″

editable=″false″/>

</props>

</item>

</items>
</set>

</fidget>

The f3 fidget is defined as a MODEL-VIEW type of fidget, which is a combination of the MODEL and VIEW types of fidgets. In the example of FIG. 5, the MODEL-VIEW type fidget f3 may be used to define a default value of a list of items as well as the presentation of the list. In that regard, the f3 fidget may be represented with the following code:

<fidget id=″f3″ type=″MODEL-VIEW″ >

<descr>

<locale key=”en”> Select a Tray</locale>

</descr>
<props>

<prop key=″visible″ type=″BOOL″ value=″true″

editable=″true″/>

<prop key=″text″ type=″STR″ value=″List″ editable=″true″ />

</props>
<set key=″trayList″ multiValued=″false″ type=″STR″ >

<items>

<item key=″auto″>

<props>

<prop key=″title″ type=″STR″ value=″Auto″ />
<prop key=″selected″ type=″BOOL″ value=″false″

editable=″true″/>

<props>

</item>
<item key=″tray_1″>

<props>

<prop key=″title″ type=″STR″ value=″Tray 1″ />
<prop key=″selected″ type=″BOOL″ value=″false″

editable=″true″/>

</props>

</item>
<item key=″tray_2″>

<props>

<prop key=″title″ type=″STR″ value=″Tray 2″ />
<prop key=″selected″ type=″BOOL″ value=″false″

editable=″true″/>

</props>

</item>

</items>

</set>
</fidget>

The f4 fidget is CUSTOM type of fidget, which may be used by the developer to define any custom behavior. In the example of FIG. 5, the CUSTOM type fidget f4 may be used to alter a logic flow of an authentication method. In that regard, the f4 fidget may be represented with the following code:

<!-- Custom fidget representing choices to alter a logical flow -

->

<fidget id=″f4″ type=″CUSTOM″ >

<descr>

<locale key=”en”> Select an Authentication

method</locale>

</descr>
<props>

<prop key=″title″ type=″STR″ value=″AuthMode″

editable=″false″ />\

</props>
<set key=″authmode″ multiValued=″false″ type=″STR″ >

<items>

<item key=″digest″>

<props>

<prop key=″title″ type=″STR″ value=″HTTP

Digest″ />

<prop key=″selected″ type=″BOOL″

value=″false″ editable=″true″/>

</props>

</item>
<item key=″oa1″>

<props>

<prop key=″title″ type=″STR″ value=″OAuth1″

/>

<prop key=″selected″ type=″BOOL″

value=″false″ editable=″true″/>

</props>

</item>
<item key=″oa2″>

<props>

<prop key=″title″ type=″STR″ value=″OAuth2″

/>

<prop key=″selected″ type=″BOOL″

value=″false″ editable=″true″/>

</props>

</item>

</items>

</set>

</fidget>

Finally, the f5 fidget is also a CUSTOM type of fidget. In the example of FIG. 5, the CUSTOM type fidget f5 may be used to alter a URL invoked by the application. In that regard, the f5 fidget, and the end of the modifiability file, may be represented with the following code:

<!-- Custom fidget to alter behavior by changing the URL to be evoked

-->

<fidget id=″f5″ type=″ CUSTOM″

include=″com.acme.app.theme/f0″>

<props>

<prop key=″title″ type=″STR″ value=″Button″ editable=″true″

/>

<prop key=″onClick″ type=″URL″

value=″intent:///#Intent;packaqe=com.acme.app.Main;end;″
editable=″true″>

<descr>

<locale key=”en”> URL to evoke on click of the button

</locale>

</descr>

</prop>
<!-- Example of a fixed (not scalable) asset -->
<prop key=″sound″ type=″ASSET″ value=″/bang.mp3″

editable=″true″ >

<descr>

<locale key=”en”> Sound to play on click of the button

</locale>

</descr>

</prop>
<!-- Example of a macro -->
<prop key=″msg″ type=″MSTR″ value=″″ editable=″true″ >

<descr>

<locale key=”en”> Some macro enabled message to

display </locale>

</descr>

</prop>

</props>

</fidget>
<fidget id=″metadata″ type=″CUSTOM″ >

<props>

<prop key=″form″ type=″MD_FORM″ value=″″ editable=″true″

>

<descr>

<locale key=”en”> File containing the user created from

description </locale>

</descr>

</prop>
<prop key=″spec″ type=″MD_SPEC″ value=″″ editable=″true″

>

<descr>

<locale key=”en”> List of macros to be sent as

metadata</locale>

/descr>

</prop>
<set key=″mime″ multiValued=″false″ type=″STR″ >

<items>

<item key=″json″>

<props>

<prop key=″title″ type=″STR″ value=″JSON″ />
<prop key=″selected″ type=″BOOL″ value=″false″

editable=″true″/>

</props>

</item>
<item key=″xml″>

<props>

<prop key=″title″ type=″STR″ value=″XML″ />
<prop key=″selected″ type=″BOOL″ value=″false″

editable=″true″/>

</props>

</item>

</items>

</set>

</props>

</fidget>

```
    </fidgets>
  </frame>
  </frames>
  <
</mof>
```

The above description has provided examples of creating a modifiability file. Examples of modifying an application using the modifiability file are now provided.

A modification file may be created by modifying editable properties specified in a modifiability file. In that regard, the ability to change an application by creating a modification file or “modding” may be provided by the electronic apparatus itself (i.e., in-app) or can be provided by an external tool (i.e., out-of-app).

In-app modding requires an application installed on an electronic apparatus to provide a editor to modify properties of various elements, including elements that do not have any user interface representation. Depending on the OS of the electronic apparatus, various aspects of the processing may be automated. For example, if the electronic apparatus uses the Android OS, processing may be automated using Android's built-in preference handling mechanism. A supplied library may read the modifiability file and map the various properties to their Android preference counterparts. As an example, various properties of a fidget may be mapped to various Android Preferences as defined in Table 12.

TABLE 12

| Property type | Android Preference |
|---|---|
| STR | EditTextPreference |
| LSTR | EditLocaleTextPreference |
| INT | EditTextPreference |
| BOOL | SwitchPreference |
| URL | EditTextPreference |
| ASSET | AssetSelectorPreference |
| COLOR | ColorSelectorPreference |

The DATA element may be mapped to either ListPreference or MultiSelectListPreference. The preferences may then be stitched together in a FidgetEditActivity.

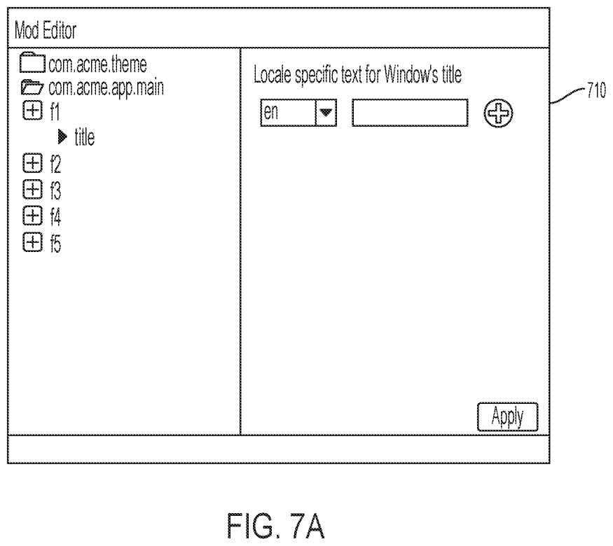

FIG. 6A illustrates a user interface that may be provided for in-app modding and FIG. 6B illustrates an activity window that may be provided to modify the user interface according to an example. Notably, the user interface illustrated in FIG. 6A is based on the example illustrated in FIG. 5 in which the application developer designated fidgets f1-f5 as modifiable.

Referring to FIG. 6A, each of the defined fidgets f1-f5 of a user interface 600 may be selected when a user presses a corresponding gear icon. For example, for the fidget f1, a gear icon 601 may be provided for user selection. Of course, this is merely an example and the user may be provided alternatives to select the fidget f1 such as by a menu, or the like.

Referring to FIG. 6B, when a user selects the gear icon 601 or otherwise selects to edit the fidget f1, a FidgetEditActivity (sub classed PreferenceActivity) 620 can be launched to configure the fidget f1. That is, the editing application may create the PreferenceActivity 620 that allows the user to edit aspects of the fidget f1 that were defined as modifiable by the application developer. In the example of FIG. 6B, the modifiability file for fidget f1 defined that the aspects of text color 621, background image for the windows title 622, and locale specific text for Windows 623 could be modified by a user of the application.

When the user's selections are concluded, the results of the selection process are returned and applied to the underlying user interface element by the developer, where applicable. This process provides the user an instant feedback, which increases the modification design efficiency.

Once the in-app modding is completed, the editor application may allow the user to directly apply the modifications to the electronic apparatus on which the user was working or otherwise connected to (in case of a mobile device) or to share the modification file (e.g., via USB, email, file copy, etc.).

Out-of-app modding is an option that may be more suitable when access to the electronic apparatus is difficult or not possible. Out-of-app modding requires the use of either a web-based editing application or a desktop-based editing application, acting as a “mod editor.” The mod-editor works off a given application package, such as an .apk package in the case of an Android OS, and provides a user interface to edit properties of various frames/fidgets. The modifiability file provides enough information for the mod-editor to render various types of properties and allow the user to make changes.

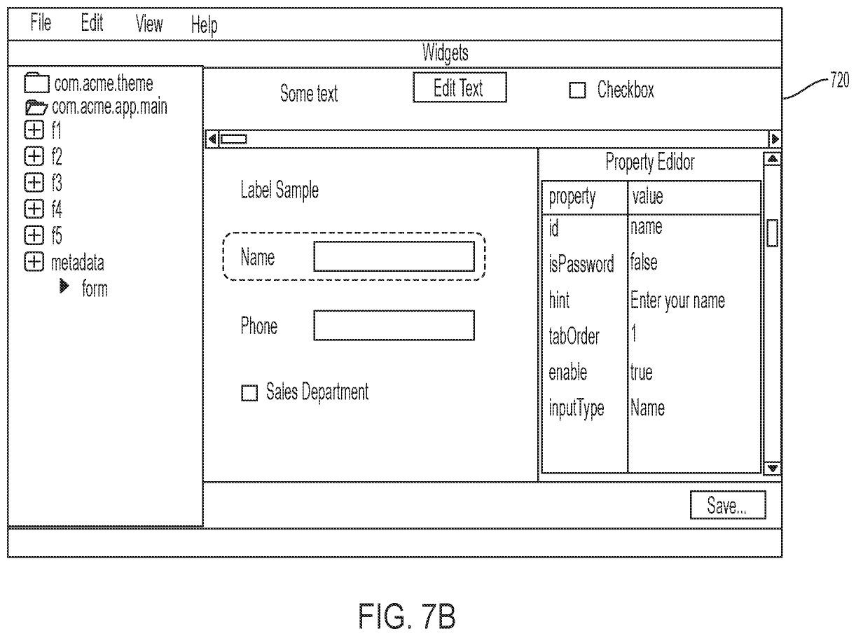

FIGS. 7A and 7B illustrate examples of a mod editor that may be provided for out-of-app modding.

Referring to FIG. 7A, a mod editor 710 may be provided for a fidget having a property type of LSTR. As described above, the fidget property type of LSTR includes a localized string for English, while remaining locales are provided using an <I10n_value> element.

Regarding a correlation between the mod editor and the modifiability file, the ‘type’ attribute (e.g., frame, fidget, property, etc.) is used to connect the mod editor and modifiability file. In that regard, it is assumed that the mod-editor is aware of how to handle each “type” appropriately and the modifiability file creator (e.g., the developer) is also aware of this capability. However, the mod-editor should also be able to deal with an unknown “type” and provide a notification or warning as appropriate.

Referring to FIG. 7B, a mod editor 720 may be provided for a fidget having a property type of MD_FORM. As described above, the fidget property type of MD_FORM designates a modifiability file allowing for an end user to create a form using widgets offered by the developers to collect metadata.

As with the in-app approach, once the modding is done, the mod-editor saves the changes in a modification file.

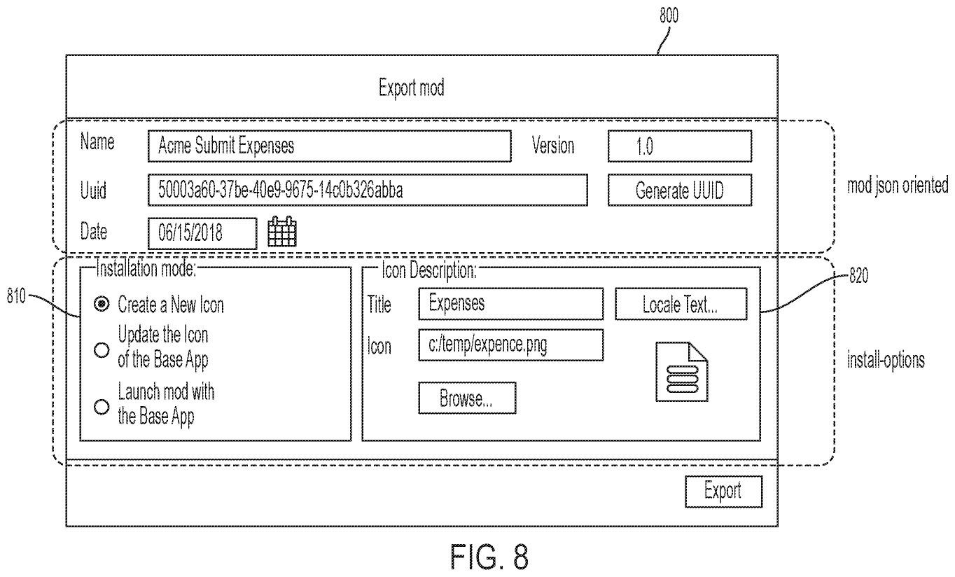

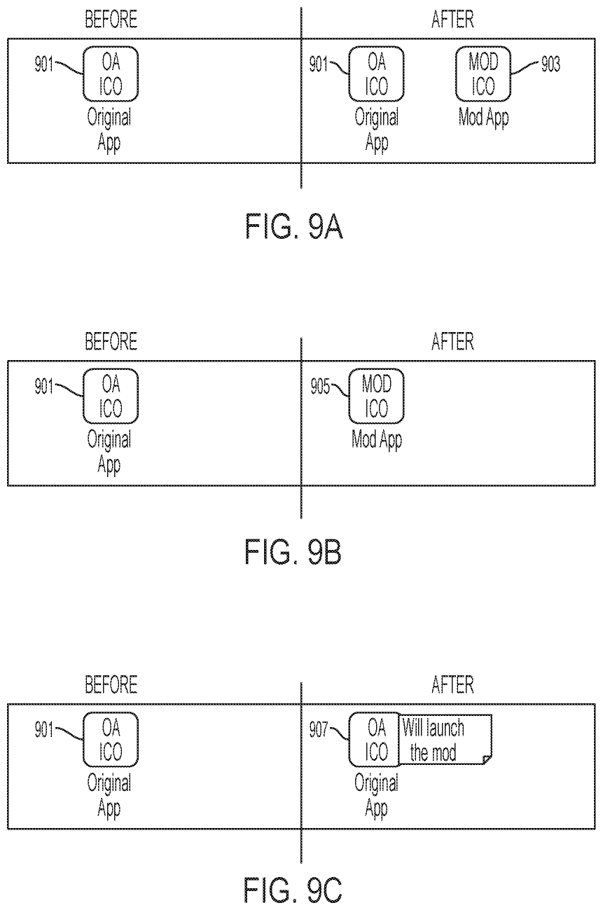

A modification file can be associated with multiple apps. For this reason, no application specific information is embedded in the mod itself. However, to support splitting of modding by a mod editor and installation of a modification file, for example by an application manager, as two discrete steps, it may be necessary to associate some application specific and installation oriented information to a mod. This association is maintained in an install-params.json file, which may be created when the user is about to save a mod. An example in which the install-params.json is created is provided with reference to FIGS. 8 and 9A-9C.

FIG. 8 illustrates a user interface provided by a mod editor according to an example. FIGS. 9A-9C illustrate top level buttons that may be displayed on an electronic apparatus before and after installation of a modification file according to various examples.

Referring to FIG. 8, a user interface 800 may be presented that includes an installation mode selector 810 as well as an icon description selector 820. Depending on the selections of the user, the top-level buttons displayed on the electronic apparatus will vary.

For example, referring to FIG. 9A, before a modification file is implemented on an electronic apparatus, a top-level button 901 may appear on an input/output interface of the electronic apparatus. When selected, the top-level button 901 would launch the original application.

If a user selects to export or otherwise install a modification file on the electronic apparatus and selects “Create a New Icon” using the installation mode selector 810, after installation and execution of the modification file, a new top-level button 903 is provided alongside the top-level button 901. In that case, an intent URL of the newly created button 903 is the same as that for the top-level button 901 of the base application (e.g., the unmodified application) except in this case, an extra string parameter carrying an id of the modification file (from the mod.json) is embedded therein. As an example, the intent URL associated with the new top-level button 903 may result as:

intentUri=intent://#Intent; package=com.acme.app; S.mod-id=5000 . . . abba; end,

which reflects the original intent URL (intentUri=intent://#Intent; package=com.acme.app) associated with the top-level button 901 and includes the extra string (S.mod-id=5000 . . . abba; end) associated with the modification file embedded therein.

Furthermore, installation modes will change depending on the options selected using the icon description selector 820. For example, in the case that the user selects or otherwise provides an icon and a title, the new top-level button 903 will be created with an id equal to the UUID of the modification file, and the icon and title as provided. In the case that the user selects or otherwise provides an icon but does not provide a title, the new top-level button 903 will be created with an id equal to the UUID of the modification file and an icon as provided, while the title displayed using a trimmed version of the modification file's name. In the case that the user does not select or otherwise provide an icon but does provide a title, the new top-level button 903 is provided with an id equal to the UUID of the modification file, an icon from the base application will be used, and the title as provided will also be used. Finally, in the case that the user does not select or otherwise provide either the icon or the title, the new top-level button 903 is created with an id equal to the UUID of the modification file, an icon from the base application is used, and a title being a trimmed version of the modification file's name will be used.

Referring to FIG. 9B, before a modification file is implemented on an electronic apparatus, the top-level button 901 may appear on the input/output interface of the electronic apparatus. If a user selects to export or otherwise install a modification file on the electronic apparatus and selects “Update the Icon of the Base App” using the installation mode selector 810, a new top-level button 905 is provided by itself. That is, the top-level button 901 will no longer be displayed after installation of the modification file. In that case, the intent URL of the base application is updated with an extra string parameter carrying the id of the modification file (from the mod.json). As an example, the intent URL associated with the new top-level button 905 may result as:

intentUri=intent://#Intent; package=com.acme.app; S.mod-id=5000 . . . abba; end,

which again reflects the original intent URL (intentUri=intent://#Intent; package=com.acme.app) associated with the top-level button 901 but includes the extra string (S.mod-id=5000 . . . abba; end) associated with the modification file.

Furthermore, installation modes will change depending on the options selected using the icon description selector 820. For example, in the case that the user selects or otherwise provides an icon and a title, the new top-level button 905 will be updated with an id equal to the base application's UUID (targetAppUuid), with the icon and title as provided. In the case that the user selects or otherwise provides an icon but does not provide a title, the new top-level button 905 will be updated with an id equal to the base application's UUID (targetAppUuid), with the icon as provided and with a title using a trimmed version of the modification file's name. In the case that the user does not select or otherwise provide an icon but does provide a title, the new top-level button 905 is created with an id equal to the base application's UUID (targetAppUuid), using the icon from the base application and using the title as provided. Finally, in the case that the user does not select or otherwise provide either the icon or the title, the title and icon of the new top-level button 905 are created with an id equal to the base application's UUID (targetAppUuid) and with the icon and title reflecting the original state of the base application (i.e. base application's default title and icon).

Referring to FIG. 9C, before the modification file is implemented on an electronic apparatus, the top-level button 901 may appear on the input/output interface of the electronic apparatus. If a user selects to export or otherwise install a modification file on the electronic apparatus and selects “Launch mod with the Base App” using the installation mode selector 810, a new top-level button 907 is provided by itself. Notably, the new top-level button 907 appears the same as the original top-level button 901. However, that the new top-level button 907 launches the modified application as opposed to the original, unmodified application. That is, while the new top-level button 907 will appear the same as the original top-level button 901, the intent URL associated with the new top-level button 907 is updated with an extra string parameter carrying the id of the modification file (from the mod.json). As an example, the intent URL associated with the new top-level button 907 may result as:

intentUri=intent://#Intent; package=com.acme.app; S.mod-id=5000 . . . abba; end,

which again reflects the original intent URL (intentUri=intent://#Intent; package=com.acme.app) associated with the top-level button 901 but includes the extra string (S.mod-id=5000 . . . abba; end) associated with the modification file. In that case, the user does not provide a new title and/or icon using the icon description selector 820 such that the modification file is simply added to the intent URL of the button with an id equal to the base application's UUID.

Finally, although not illustrated, a modification may be silently installed in which the modification file is installed but does not have a button associated with it. Such a mod may be evoked either via an explicit intent or rely on the base application to employ some type of logic to apply the modification file.

Irrespective of whether in-app or out-of-app modding is used, the net effect of modding is the creation of a modification file, which contains all the edited changes and all the user supplied assets. Except for certain metadata of the mod, the structure of the modification file is essentially the same as of the modifiability file. The following is an example of operations taken to convert a modifiability file to a modification file.

In a first operation, the following meta-data is added: <GUID>, <name>, <version>, <mfVersion>, <date>. In a second operation, all read only elements are stripped. e.g. <descr>. In a third operation, all frames of type MACRO or WIDGET are stripped. In a fourth operation, all non-editable properties (i.e., <prop>) are stripped. In a fifth operation, dependencies are resolved by merging included properties. For example, if fidget A includes properties from fidget B, fidget B's properties are copied into fidget A. Fidget B is not then required. This is done to avoid this operation at the mod application time. It should be understood that in the above described example, the first through fifth operations are not meant to limit an order in which the processes are started, carried out, or completed.

As an example of creating a modification file, reference is again made to FIG. 5 which included the fidgets f1-f5. Again, the fidgets f1-f5 were designated by the application developer as aspects of the application that may be modified by a user. Table 13 lists sample modifications that may be selected by a user of the application regarding fidgets f1-f5 as well as metadata that may also be selected by the user.

TABLE 13

| Fidget | Description of change |
|---|---|
| f1 | Localized title changed to “Sample App” |
| | Back ground image change to the user supplied |
| | banner.jpg (theme change) |
| f2 | Choice A, B were selected |
| f3 | Title was changed and Tray 1 was selected |
| f4 | OAuth2 was selected |
| f5 | Title was changed to “Go Home” |
| | onClick URL was changed |
| | sound file was changed to user supplied Ding.mp4 |
| | msg was set to “Device IP: {HOST_IP}.” |
| metadata | User created a form to collect metadata (name, |
| | phone, dept) and saved it in myForm.xml |

When using a mod-editor as described above, the changes of Table 13 are captured in a mod.json file, along with any assets. The modification file, having a form similar to the underlying modifiability file, would result as follows:

{

“_noNamespaceSchemaLocation”:

“http://some.host.hp.com/JetAdvantageLink/App/ModSchema.xsd”.

“_schemaVersion”: “1.1”,
“id”: “dead...babe”
“name”: “My Mod”,
“version”: “1.0”,
“date”: “06/18/2018”,
“mfVersion”: “1.1”,
“frames”: {

“frame”: {

“_id”: “com.acme.app.main”,
“fidgets”: [

{

“_id”: “f1”,
“props”: [

{

“_key”: “backgroundImage”,
“_value”: “banner.png”

},
{

“_key”: “title”,
“_value”: “”,
“|10n_value”: {

“locale”: [
{

“_key”:“fr”,
“value”:“Exemple

d'application”

},{

“_key”:“es”,
“value”:“Aplicacion de

muestra”

}

]

}

}

]

},
{

“_id”: “f2”,
“set”: {

“_key”: “choices”,
“_multiValued”: “true”,
“items”: [

{

“_key”: “choice_a”,
“props”: {

“prop”: {

“_key”: “selected”,
“_value”: “true”

}

}

},
{

“_key”: “choice_b”,
“props”: {

“prop”: {

“_key”: “selected”,
“_value”: “true”

}

}

}

]

}

},
{

“_id”: “f3”,
“props”: {

“prop”: {

“_key”: “text”,
“_value”: “Modified List”

}

},
“set”: {

“_key”: “trayList”,
“_multiValued”: “false”,
“items”: {

“item”: {

“_key”: “tray_1”,
“props”: {

“prop”: {

“_key”: “selected”,
“_value”: “true”

}

}

}

}

}

},
{

“_id”: “f4”,
“set”: {

“_key”: “authmode”,
“_multiValued”: “false”,
“items”: {

“item”: {

“_key”: “oa2”,
“props”: {

“prop”: {

“_key”: “selected”,
“_value”: “true”

}

}

}

}

}

},
{

“_id”: “f5”,
“props”: [

{

“_key”: “title”,
“_value”: “Go Home”

},
{

“_key”: “onClick”,
“_value”:

“intent:///#Intent;package=com.acme.mvapp.Main;end;”

},
{

“_key”: “sound”,
“_value”: “/ding.mp4”

},
{

“_key”: “msg”,
“_value”: “Device IP: {HOST_IP}”

},
{

“_key”: “backgroundImage”,
“_value”: “banner.png”

}

]

},
{

“_id”: “metadata”,
“props”: [

{

“_key”: “form”,
“_value”: “/myForm.xml”

}

]

}

]

}

}

}

Further to the above example, it may be assumed that during the saving of the modification file, the user selects the “Create a New Icon” option using the installation mode selector 810 and provides a title as “Expense” and an icon as “expense.png” using the icon description selector 820. Accordingly, the following install-params.json may be created:

{

“version”: “1.0.0”,
“targetAppUuid”: “50003a60-37be-40e9-9675-14c0b326abba”,
“installMode”: “CreateNewIcon”,
“icon”: {

“url”: “file://expense.png”,
“title”: {

“en-US”: “Expenses”,
“fr-FR”: “Dépenses”

}

}

}

which results in a modification file labelled MySample.mod and having the parameters as shown in Table 14.

TABLE 14

| | | |
|---|---|---|
| mod.json | | |
| install-params.json | | |
| expense.png | | |
| /res | | |
| | ding.mp4 | |
| | myForm.xml | |
| | /x0.75 | |
| | | banner.png |
| | /x1 | |
| | | banner.png |
| | /x2 | |
| | | banner.png |
| | /x3 | |
| | | banner.png |

Once the modification file is created, it is necessary to deliver the modification file to the target electronic apparatus. Other actions must also be considered such as modification file archival and retrieval, listing, associating with an application or an account, automatic installation of the modification file, etc. From the distribution/publishing perspective, mods can be treated similar to the same way an application's configuration is treated. For example, a core service may provide an application programming interface (API) for mod listing, archive and retrieval. These mods can then be installed using mod installation APIs.

A mod may be installed on a device using a package manager such the extended Pacman WS mod APIs or as part of an application installation package such as an .apk file. As an example of a mod installation, a description is provided assuming a mod is installed using the Pacman WS APIs.

For mod installation or update, the following code may be used:

POST /pkgmgt/packages/<uuid>/mods/install HTTP/1.1
Content-Type: multipart/form-data; boundary=1908075648
Content-Length: ##
--1908075648
Content-Disposition: form-data; name=″file″; filename=“acme submit
expense.mod″
Content-Type: application/vnd.hp.mod-archive

A mod may be updated, including updating of the top-level button's, the title, the icon, and the mod's content, by simply re-installing it. A client may disable this default behavior by supplying a query parameter ‘overwrite=false’, in which case, the installation would fail if a mod with the given mod-id already existed.

Install status and progress may be monitored irrespective of the installation type. As an example, the installation status/progress can be monitored via the following end points:

POST /pkgmgt/packages/<uuid>/mods/install
GET /pkgmgt/packages/<uuid>/mods/install/<mod-id>

After a successful installation of the mod, a broadcast or other notice may be provided. An example broadcast that may be sent out is provided in Table 15.

TABLE 15

| String Mnemonic | “ACTION_MOD_INSTALLED” | |
|---|---|---|
| Action | com.hp.android.intent.action.MOD_INSTALLED | |
| Extras | Key | Description |
| | EXTRA_UUID | UUID of the package for |
| | | which the mod was |
| | | installed |
| | EXTRA_MOD_ID | Mod-id of the mod |
| | | installed |

An endpoint may be provided as to the content of a modification file. As an example, the following endpoint provides the content of the mod.json:

GET /pkgmgt/packages/<uuid>/mods
GET /pkgmgt/packages/<uuid>/mods/<mod-id>

The assets of a mod may be exposed by a package manager. As an example, the assets of a mod may exposed via a Pacman hosted FileProvider URI, such as:

content://com.smartuxservice.packagemanager/<mod-
id>/assets/Ding.mp4

or for a density sensitive asset by:

content://com.smartuxservice.packagemanager/<mod-
id>/assets/x2/bg.jpg

The content of the install-params.json are not exposed to the applications but are meant only for an installer entity.

It may also be required to uninstall a mod. As an example, a mod may be uninstalled via the following endpoint:

DELETE /pkgmgt/packages/<uuid>/mods/<mod-id>

A notification may be provided after a successful uninstallation of a mod. An example of a broadcast notification that may be sent out is provided in Table 16.

TABLE 16

| String Mnemonic | “ACTION_MOD_UNINSTALLED” | |
|---|---|---|
| Action | com.hp.android.intent.action.MOD_UNINSTALLED | |
| Extras | Key | Description |
| | EXTRA_UUID | UUID of the package for |
| | | which the mod was |
| | | installed |
| | EXTRA_MOD_ID | Mod-id of the mod |
| | | uninstalled |

If there was a top-level button associated with the mod, the button is also uninstalled. Also, all mods for an application are implicitly uninstalled when the underlying application is uninstalled.

A mod supporting application must traverse its embedded manifest and, for each editable fidget, retrieve corresponding properties from the provided modification. The application must apply these values appropriately. The following is an example of a package to assist the application with the manifest traversal (.mof) and properties retrieval (.mod) in a seamless manner:

Mod getMod(mod-id)
Frame Mod.getFrames(type), Frame Mod.getFrames( )
Frame Mod.getFrame(fid)
ArrayList<Fidget> Frame.getFidgets( )
ArrayList<Fidget> Frame.getFidgets(type)
Fidget Frame.getFidget(fid)
Property Fidget.getProperty(name)
ArrayList<Items> Fidget.getItems(name)
Uri Mod.getAssetUri(name)
Drawable Mod.getDrawable(size, name)

As a further example, the following code snippet shows how the application can use the modReader APIs to apply the mod:

Mod mod = new Mod(modId);
// Get Frame for my main window
Frame frmMain = mod.getFrame(“com.acme.app.main”);
// f1 handling
Fidget f1 = frmMain.getFidget(“f1”);
// textColor
Property textColor = f1.getProperty(“textColor”);
View view = activity.findViewById(0);
if (textColor != null) {

view.setBackgroundColor(Integer.parseInt(textColor.mValue));

}
// backgroundImage
Property bkgImage = f1.getProperty(“backgroundImage”);
if (bkgImage != null) {

Drawable bd = mod.getDrawable(bkgImage.mValue, DENSITY_LOW);
view.setBackground(bd);

}
// title
Property title = f1.getProperty(“title”);
if (title != null) {

CharSequence cst = title.getL10nValue( );
// set Text

}
// Handle f2
// Handle f5

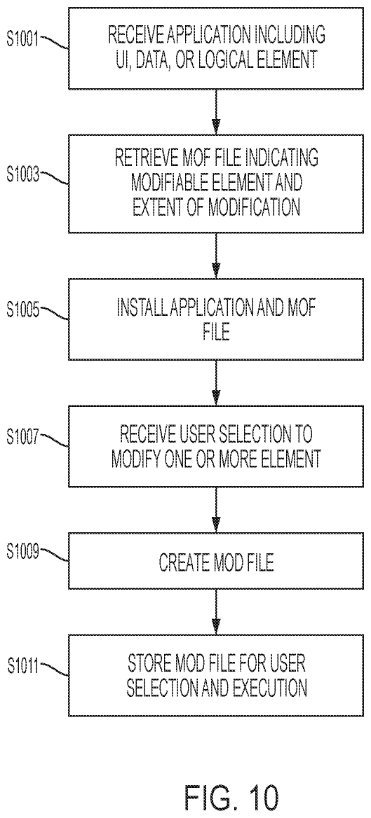

FIG. 10 illustrates a method of operating an electronic apparatus according to an example.

Referring to FIG. 10, an application including at least one of a user interface (UI) element, a data element, or a logical element is received by the electronic apparatus in operation S1001. In operation S1003, a modifiability file indicating one or more of the at least one of the user interface (UI) element, the data element, or the logical element of the application that can be modified and an extent of the modifiability is received. In operation S1005, the application including the modifiability file is installed on the electronic apparatus. In operation S1007, a user selection to modify one or more of the UI element, the data element, or the logical element is received and in operation S1009, a modification file is created based on the user modification. In operation S1011, the modification file is stored for user selection and execution.

A method as described above may be implemented in a form of a computer-readable storage medium storing data or instructions executable by a computer or a processor. The method may be written as a computer program and may be implemented in general-use digital computers that execute the programs using a non-transitory computer-readable storage medium. Examples of the computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disk (SSD), and any devices that may store instructions or software, related data, data files, and data structures and may provide instructions or software, related data, data files, and data structures to a processor or a computer to allow the processor or the computer to execute instructions.

While the present disclosure has been described with reference to the drawings and particular examples, those of ordinary skill in the art may make various changes and modifications therein without departing from the spirit and scope of the present disclosure. For example, the described techniques may be performed in a different order than the described method, and/or the described components such as systems, structures, devices, and circuits may be united or combined in a different form than the described method or may be replaced or substituted by other components or equivalents thereof.

What is claimed is:

1. An electronic apparatus comprising:
an input/output device;
a memory having installed therein:
an application including at least one of a user interface (UI) element, a data element, or a logical element, and
a modifiability file indicating one or more of the at least one of the user interface (UI) element, the data element, or the logical element of the application that can be modified and an extent of the modifiability; and
a processor to execute the application,
wherein, when one or more of the UI element, the data element, or the logical element are modified based the modifiability file, a modification file is created and installed in the memory for user selection and execution by the processor.

2. The electronic apparatus of claim 1,
wherein the processor executes the application that has not been modified based on a user selection of a first menu button displayed on the input/output device, and
wherein installation of the modification file includes at least one of displaying of a second menu button for selection of the modified application or modification of the first menu button to launch the modified application.

3. The electronic apparatus of claim 1, wherein each of the modifiability file and the modification file is agnostic with regard to a UI technology of an operating system of the electronic apparatus.

4. The electronic apparatus of claim 1, wherein the modifiability file is packaged at least one of separate from or together with the application.

5. The electronic apparatus of claim 1,
wherein a plurality of modifiability files may be associated with the application, and
wherein a plurality of modification files may be applied to the application.

6. The electronic apparatus of claim 1, wherein the modification to the application based on the modifiability file is performed by a user at the electronic apparatus or by the user at a remote device.

7. The electronic apparatus of claim 1, wherein the modifiability file allows a user to change the application by creating a form associated with the UI element of the application.

8. A method of operating an electronic apparatus, the method comprising:
receiving an application including at least one of a user interface (UI) element, a data element, or a logical element;
receiving a modifiability file indicating one or more of the at least one of the user interface (UI) element, the data element, or the logical element of the application that can be modified and an extent of the modifiability;
installing the application including the modifiability file on the electronic apparatus;
receiving a user selection to modify one or more of the UI element, the data element, or the logical element;
creating a modification file based on the user modification; and
storing the modification file for user selection and execution.

9. The method of claim 8, further comprising:
displaying a first menu button for user selection of the application that has not been modified; and
at least one of displaying a second menu button for selection of the modified application or modifying the first menu button to launch the modified application.

10. The method of claim 8, wherein each of the modifiability file and the modification file is agnostic with regard to a UI technology of an operating system of the electronic apparatus.

11. The method of claim 8, further comprising at least one of packaging the modifiability file separate from or together with the application.

12. The method of claim 8, further comprising:
receiving a plurality of modifiability files associated with the application; and
applying a plurality of modification files to the application.

13. The method of claim 8, wherein the modifying of the application based on the modifiability file is performed by a user at the electronic apparatus or by the user at a remote device.

14. The method of claim 8, further comprising changing the application by creating a form associated with the UI element of the application based on the modifiability file.

15. A computer readable medium embodying a file structure for installation of an application on an electronic apparatus, the file structure comprising:
a first container including an application installation file corresponding to the operating system, the application installation file including at least one of a user interface (UI) element, a data element, or a logical element; and
a second container including asset information for the application installation file,
wherein the asset information for the application installation file includes modifiability information indicating one or more of the at least one of the user interface (UI) element, the data element, or the logical element of the application that can be modified and an extent of the modifiability.
